(19) United States
(12) Patent Application Publication
(10) Pub. No.: US 2008/0105072 A1
(43) Pub. Date: May 8, 2008

(54) ROTARY HOLDING DEVICE FOR A MACHINING APPARATUS

(76) Inventor: Hsi-Kuan Chen, Taichung Hsien (TW)

Correspondence Address: BANNER & WITCOFF, LTD., 1100 13th STREET, N.W., SUITE 1200, WASHINGTON, DC, 20005-4051, US

(21) Appl. No.: 11/555,725

(22) Filed: Nov. 2, 2006

(51) Int. Cl. F16H 1/16

(52) U.S. Cl. 74/425

(57) ABSTRACT

A rotary holding device includes a drive axle disposed within a housing, a worm gear supported by the drive axle and having a helical thread, a driven axle disposed within the housing and perpendicular to the drive axle, a rotary holder carried by the driven axle, and first and second drive discs mounted coaxially on the driven axle respectively at two opposite sides of the worm gear. Each of the first and second drive discs has an inner face provided with a plurality of axially projecting and angularly spaced-apart rollers that mesh with the helical thread of the worm gear.

### BACKGROUND OF THE INVENTION

1. Field of the Invention

The invention relates to a machining apparatus, more particularly to a rotary holding device for a machining apparatus.

2. Description of the Related Art

A typical numerical control (NC) machining apparatus is generally provided with one or more tools that can make linear movements along three axes, namely, X, Y, and Z axes, to perform indexing and machining, such as cutting. However, since the tool only moves linearly along these axes and cannot be controlled to machine angularly a workpiece, the NC machining apparatus is normally provided with a rotary holding device, such as the so-called fourth-axis rotary table for holding workpieces. With the fourth-axis rotary table, the workpieces can undergo rotary processing steps, such as indexing, contouring, etc.

Referring to FIG. 1, a conventional NC fourth-axis rotary table 10 includes a drive unit 11 and a driven unit 12. The drive unit 11 has a drive axle 111, and a cylindrical cam 112 disposed on the drive axle 111 and having a helical thread 1121 with a predetermined pitch. The drive axle 111 has one end connected to a motor (not shown) that serves as a driving source. The driven unit 12 has a driven axle 121 perpendicular to the drive axle 111, and a drive disc 122 connected to the driven axle 121. The driven axle 121 has one end connected to a rotary disc (not shown), where workpieces are fixed. The drive disc 122 moves simultaneously with the driven axle 121, and is provided with a plurality of circumferentially spaced-apart rollers 1221 to mesh with the helical thread 1121.

When the drive axle 111 rotates, the cylindrical cam 112 rotates the drive disc 122 to a predetermined angle through the helical thread 1121. As such, the workpiece that is fixed on the rotary disc can also make an angular rotation to undergo a machining process.

Although the aforementioned conventional NC fourth-axis rotary table 10 can achieve its intended purpose, it has the following drawbacks:

1. In order to enable the rollers 1221 to mesh deeply with the helical thread 1121, the bottom land of the helical thread 1121 must be concaved to have a curvature conforming to the circumference of the drive disc 122. As such, rotational precision can be enhanced, the disadvantage of speed differences resulting from the use of the conventional involute gear can be eliminated, and the service lives of the cylindrical cam 112 and the drive disc 122 can be prolonged. However, this requires a special machine to form the helical thread 1121 of the cylindrical cam 112, so that the manufacturing cost of the entire cylindrical cam 112 is very high.

2. Due to the relative sliding movements of the helical thread 1121 and the rollers 1221, it is difficult to brake accurately and effectively the drive disc 122 through the cylindrical cam 112. When the workpiece undergoes a heavy cutting operation, the drive disc 122 cannot bear a high load torque of the cutting operation, thereby resulting in positional deviation that leads to dimensional inaccuracy of the workpiece.

3. As a result of the above drawback, the conventional rotary table 10 must depend on a motor for braking, and the motor must be a heavy duty one in order to sufficiently counteract the torque during the heavy cutting operation of the workpiece. This results in enlarging the entire volume of the rotary table 10 and in increasing the equipment cost.

4. Since the drive disc 122 meshes with the cylindrical cam 112 on a horizontal plane, the volume of the conventional rotary table 10 has to be enlarged horizontally. Hence, the conventional rotary table 10 occupies a substantial space in a limited working space of a machine tool.

### SUMMARY OF THE INVENTION

Therefore, the object of the present invention is to provide a rotary holding device that can bear a high load torque and that can be manufactured at a relatively low cost.

According to this invention, a rotary holding device comprises a drive axle disposed within a housing, a worm gear supported by the drive axle and having a helical thread, a driven axle disposed within the housing and perpendicular to the drive axle, a rotary holder carried by the driven axle, and first and second drive discs mounted coaxially on the driven axle respectively at two opposite sides of the worm gear. Each of the first and second drive discs has an inner face provided with a plurality of axially projecting and angularly spaced-apart rollers that mesh with the helical thread of the worm gear.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled schematic view of a conventional NC fourth-axis rotary table;

FIG. 2 is an exploded perspective view of the preferred embodiment of a rotary holding device according to the present invention;

FIG. 3 is an assembled perspective view of the preferred embodiment;

FIG. 4 is a sectional view of the preferred embodiment taken along line 4-4 of FIG. 3;

FIG. 5 is a sectional view of the preferred embodiment taken along line 5-5 of FIG. 3; and

FIG. 6 is a sectional view of the preferred embodiment taken along line 6-6 of FIG. 3.

### DETAILED DESCRIPTION OF THE PREFERRED EMBODIMENT

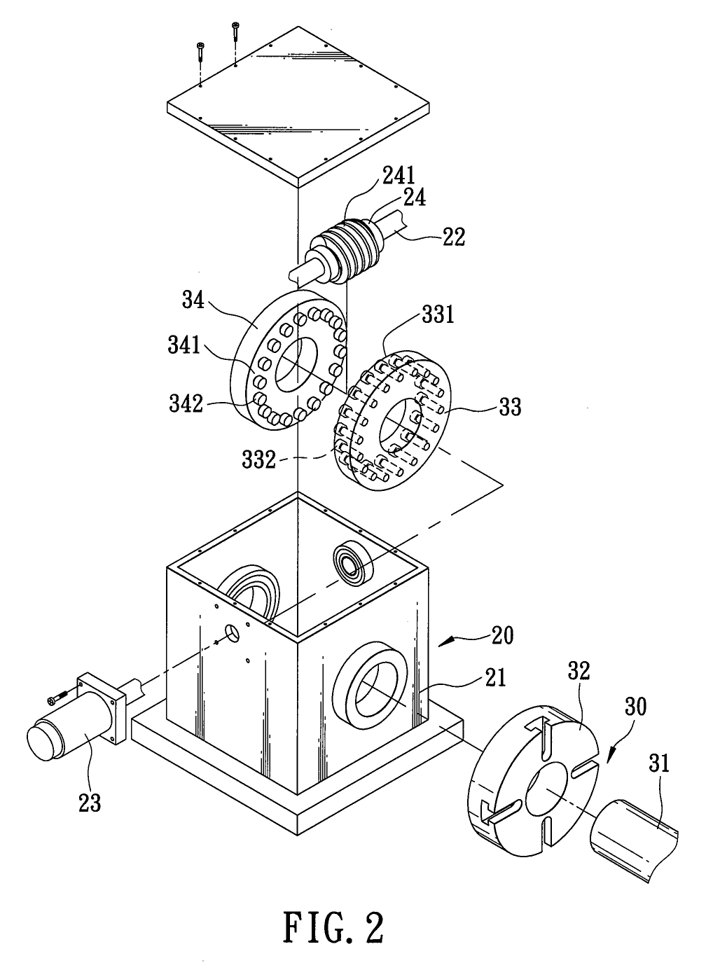

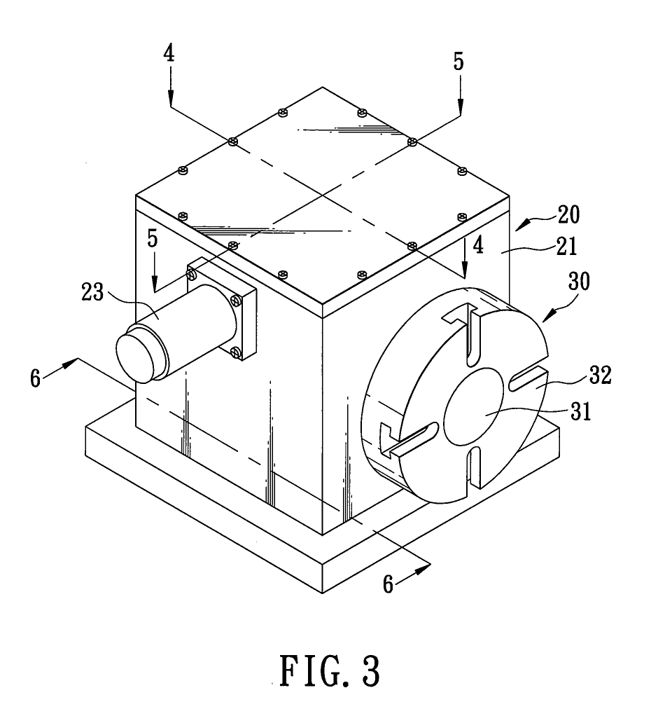

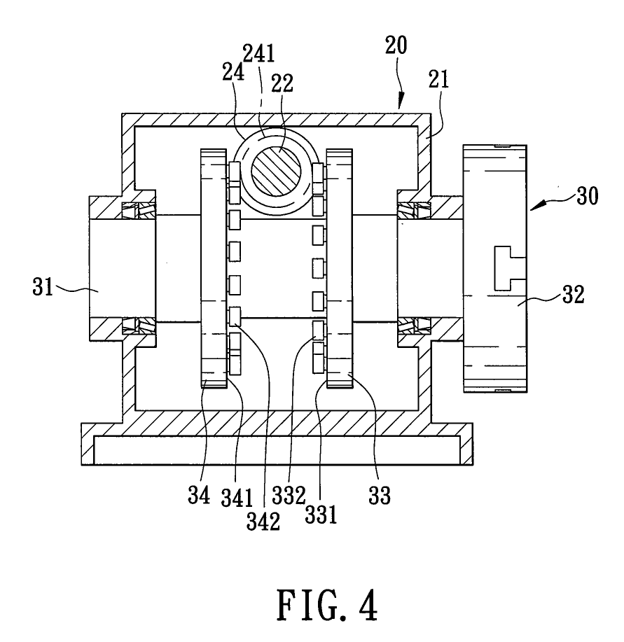

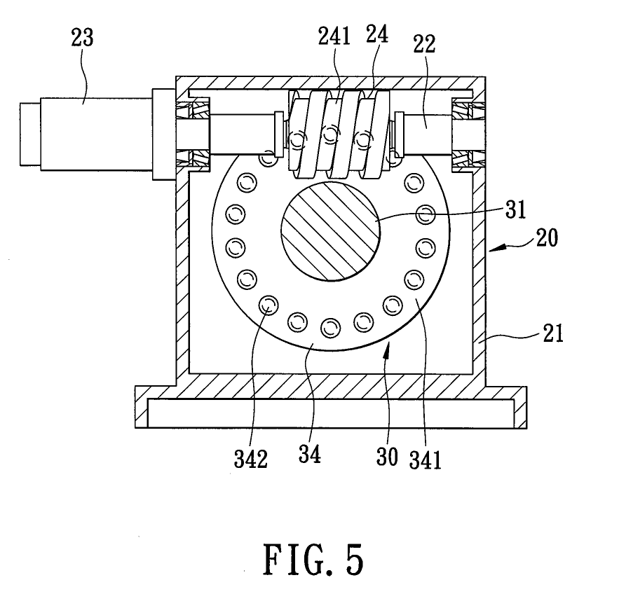

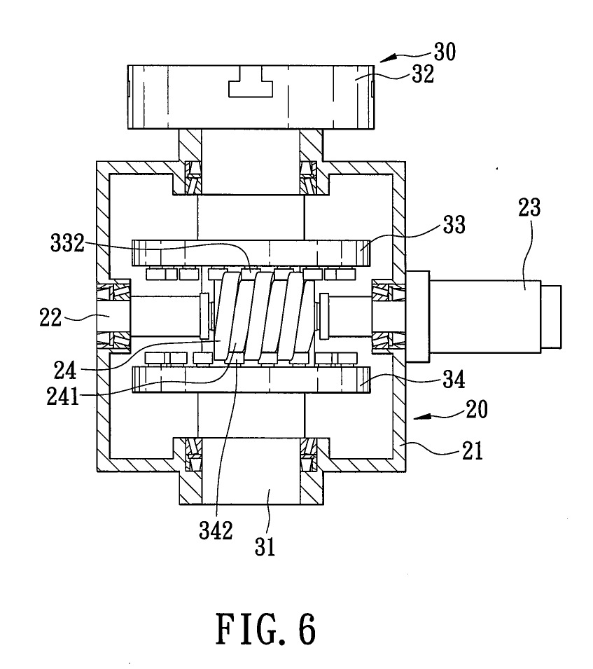

Referring to FIGS. 2 to 6, the preferred embodiment of a rotary holding device 20 according to the present invention is shown to comprise a housing 21, a drive axle 22 disposed within the housing 21, and a motor 23 connected to and disposed outwardly of the housing 21 for driving rotation of the drive axle 22. A worm gear 24 having a helical thread 241 is disposed within the housing 21, and is supported by the drive axle 22. In this embodiment, the helical thread 241 of the worm gear 24 has a substantially square cross section. The motor 23 may be a servo motor, an AC motor, or a hydraulic motor.

The rotary holding device 20 further has a driven axle 31 disposed within the housing 21 and perpendicular to the drive axle 22, a rotary holder 32 carried by the driven axle 31 and disposed outwardly of the housing 21, a first drive disc 33 mounted rotatably on the driven axle 31 and meshing with the worm gear 24 at one side of the worm gear 24, and a second drive disc 34 mounted rotatably on the driven axle 31 and meshing with the worm gear 24 at the other side of the worm gear 24. Each of the first and second drive discs 33, 34 has an inner face 331, 341 facing the worm gear 24 and provided with a plurality of axially projecting and angularly spaced-apart rollers 332, 342 that mesh with the helical thread 241 of the worm gear 24.

The advantages of the rotary holding device 20 of the present invention are as follows:

1. The present invention makes use of the rollers 332, 342 of the first and second drive discs 33, 34 to mesh with the helical thread 241 of the worm gear 24. The first and second drive discs 33, 34 rotate coaxially with the rotary holder 32. When workpieces (not shown) are attached to the rotary holder 32 to undergo machining, the worm gear 24 rotates simultaneously the first and second drive discs 33, 34 which simultaneously drive the driven axle 31. Through such dual driving of the driven axle 31 by both the first and second drive discs 33, 34, the rotary holder 32 can sufficiently bear a high load torque of a heavy cutting operation. The present invention is thus suitable for a heavy cutting process of the workpiece.

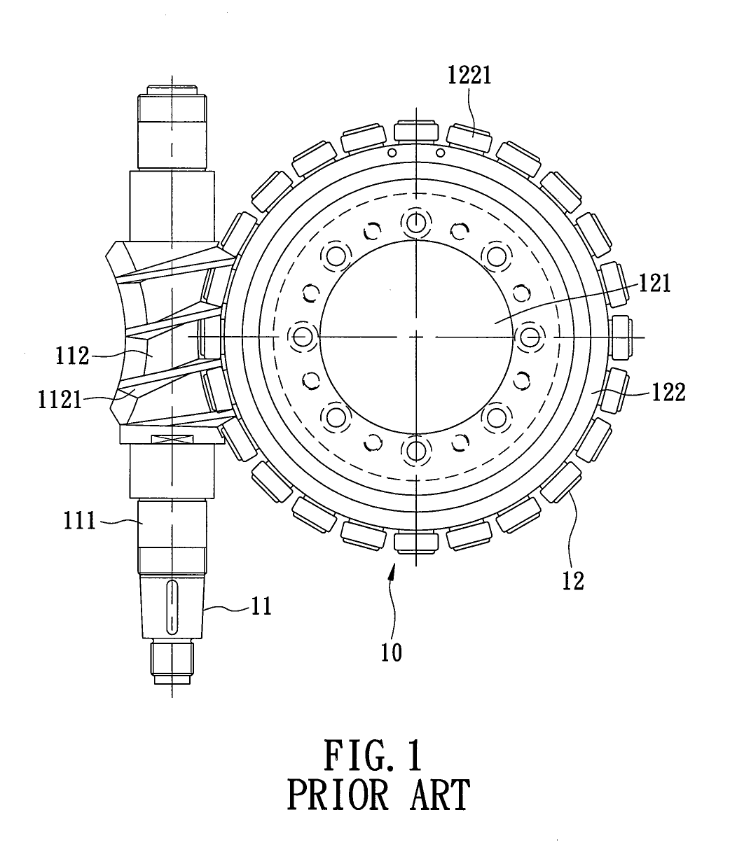

2. The worm gear 24 used in this invention has a common structure of the conventional worm gear that can be produced at a low cost. This can reduce the entire production cost of the rotary holding device of the present invention when compared with the conventional NC fourth-axis rotary table 10 shown in FIG. 1. Further, since the helical thread 241 of the worm gear 24, which has a substantially square cross section, provides a considerable bearing contact surface area to contact the rollers 332, 342, the rollers 332, 342 can be effectively prevented from undergoing reverse rotation, thereby resulting in an effective braking action. Hence, the present invention does not require the use of the motor 23 as a brake, thereby allowing for the use of a low power device for the motor 23. This further reduces the cost of production.

3. Since (a) the rollers 332, 342 are provided on the inner faces of the first and second drive discs 33, 34 rather than on the outer peripheries thereof, (b) the worm gear 24 is sandwiched between the inner faces of the first and second drive discs 33, 34, and (c) the first and second drive discs 33, 34 extend in vertical planes, the housing 21 of the present invention extends downward and upward so that the dimensions of the rotary holding device of the present invention in horizontal directions can be reduced. Hence, the present invention can be disposed on a limited area of a machine body.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A rotary holding device for a machining apparatus, comprising:
a housing;
a drive axle disposed within said housing;
a worm gear supported by said drive axle and having a helical thread;
a driven axle disposed within said housing and perpendicular to said drive axle;
a rotary holder carried by said driven axle; and
first and second drive discs mounted coaxially on said driven axle respectively at two opposite sides of said worm gear, each of said first and second drive discs having an inner face provided with a plurality of axially projecting and angularly spaced-apart rollers that mesh with said helical thread of said worm gear.

2. The rotary holding device of claim 1, wherein said helical thread of said worm gear has a substantially square cross section.
